(19) United States
(12) Patent Application Publication
(10) Pub. No.: US 2017/0194998 A1
(43) Pub. Date: Jul. 6, 2017

(54) ELECTRONIC DEVICE HOLDER

(71) Applicant: Angela Irvine, Lansing, MI (US)

(72) Inventor: Angela Irvine, Lansing, MI (US)

(21) Appl. No.: 15/386,380

(22) Filed: Dec. 21, 2016

Related U.S. Application Data
(63) Continuation-in-part of application No. 14/988,131, filed on Jan. 5, 2016, now abandoned.

(51) Int. Cl. H04B 1/3888; H04M 1/02

(52) U.S. Cl. CPC H04B 1/3888; H04M 1/0202

(57) ABSTRACT

An electronic device holder for supporting a portable electronic device that includes: a four sided case, where the case secures the portable electronic device; a handle attached to a first corner of the case, where the handle includes a pivot point; an open position for the handle; and a closed position for the handle, where the pivot point enables the toggle between the open position and closed position. The handle includes a gripping side that remains on the outside surface of the case and an inside surface that abuts the case on a first side, where the gripping side may include a set of ridges adapted to assist a user in gripping and holding the handle. Further, the case may include an opening that allows for a camera lens opening aligned with a camera lens used on the portable electronic device.

### BACKGROUND OF THE INVENTION

Field of Invention

The present invention is related to an electronic device holder that includes an extendable handle to assist in holding and manipulating the device during use.

Description of Related Art

Hand-held electronic devices such cellular phones, MP3 players, portable cameras or video recorders have inundated the consumer market. The typically handheld electronic devices may be easily placed into a user's pocket or a bag. Further these hand held devices commonly are used with a holder or case that encloses the electronic device and protects it from damage if dropped on a hard surface. Further some cases have been developed that are waterproof and protects the electronic device if it's accidently immersed into water. Because of the wide variety of electronic devices there are various types of holders that have been developed for security and stylist purposes. Many handheld devices include the ability to capture images with a camera, either still images or video. Typically, the typical smart phone or electronic device is a small rectangular device that less than 5-inches in length and normally 2-3 inches or so in width. If individuals are using the electronic device for video recording or capturing multiple images, it can be difficult to hold the small device of a long period of time. Consequently, it would be advantageous to have a holder that included a handle that was extended and available for use by a user while taking a video or still images.

### SUMMARY OF THE INVENTION

The present invention relates to an electronic device holder for supporting a portable electronic device that includes: a four sided case, where the case secures the portable electronic device; a handle attached to a first corner of the case, where the handle includes a pivot point; an open position for the handle; and a closed position for the handle, where the pivot point enables the toggle between the open position and closed position. The handle includes a gripping side that remains on the outside surface of the case and an inside surface that abuts the case on a first side, where the gripping side may include a set of ridges adapted to assist a user in gripping and holding the handle. Further, the case may include an opening that allows for a camera lens opening aligned with a camera lens used on the portable electronic device.

### BRIEF DESCRIPTION OF DRAWINGS

FIG. 1 depicts a smart phone holder in accordance with the present invention in an open position.

FIG. 2 depicts the smart phone holder where the handle is in a closed position.

### DETAILED DESCRIPTION

The present invention relates to a smart phone or an electronic device holder that receives an electronic device within a case. The case secures the electronic device during use. Further a handle is provided which extends in an open position or closes onto one side of case in a closed position. The extendable and retractable handle provides an extension from the case for a user to hold during use of the electronic device. The handle in accordance with the present invention may include a knuckle grip to provide a gripping feature for the handle. Further in one particular embodiment the handle may have a telescoping extension feature to increase the length of a handle when in an open position. The handle closes and abuts to one side of the case when not in use.

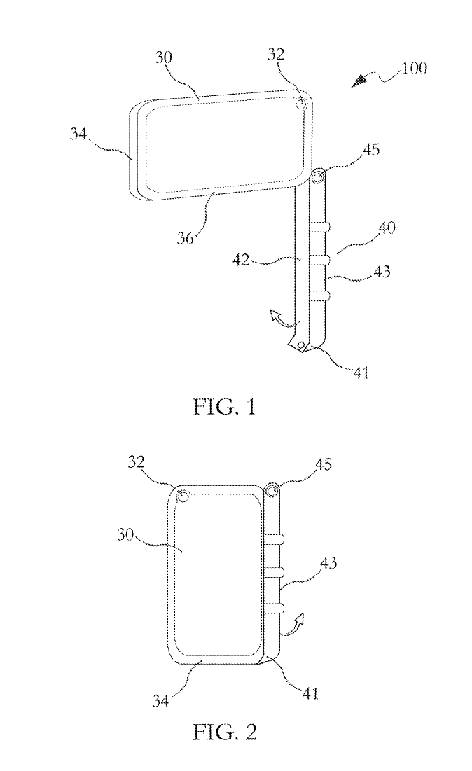

In reference to FIG. 1, an electronic device holder 100 in accordance with the present invention is depicted. The electronic device holder 100 includes a case 30 that provides the means to secure the electronic device in a stationary position. The case 30 includes an outside edge 34 and an inside edge 36 that abuts to one side of a handle 40 shown in FIG. 1. The handle 40 extends from one corner of the case 30 and includes a pivot point 45 that allows for the pivoting of the handle 40 between an open and closed position. The handle 40 also has an inside surface 42 that abuts the side 36 of the case 30. A distal end 41 is shown that it is opposite of the pivot point 45 on the handle 40. Further the handle 40 includes a gripping side 43, which may include a set of ridges or grips to assists the user in gripping and holding the handle 40 during use.

FIG. 2 depicts the handle 40 in a closed position. As shown the handle 40 is secured along side 36 of the case 30. Further the case 30 includes an opening 32 that allows for the camera lens to have an opening and is aligned with a camera lens used on the electronic device. This closed position allows the user to place the case and handle in a pocket or bag when the handle is not being used. Further the handle doesn't interfere with the use of the electronic device when in the closed position as shown in FIG. 2. The instant invention has been shown and described in what it considers to be the most practical and preferred embodiments. It is recognized, however, that departures may be made there from within the scope of the invention and that obvious modifications will occur to a person skilled in the art.

What is claimed is:

1. An electronic device holder for supporting a portable electronic device comprising:
a four sided case, where the case secures the portable electronic device;
a handle attached to a first corner of the case, where the handle includes a pivot point;
an open position for the handle; and
a closed position for the handle, where the pivot point enables the toggle between the open position and closed position.

2. The electronic device holder according to claim 1, where the handle includes a gripping side that remains on the outside surface of the case and an inside surface that abuts the case on a first side.

3. The electronic device holder according to claim 1, where the gripping side includes a set of ridges adapted to assist a user in gripping and holding the handle.

4. The electronic device holder according to claim 1, where the case includes an opening that allows for a camera lens opening aligned with a camera lens used on the portable electronic device.
